(19) United States
(12) Patent Application Publication
(10) Pub. No.: US 2023/0035226 A1
(43) Pub. Date: Feb. 2, 2023

(54) Method and Homogeneous Filament Material 3D Printed Radial Flow Fluid Treatment System

(71) Applicant: Stonehouse Innovations, LLC, Jackson, WI (US)

(72) Inventors: Marwick Hensley Foster, Milwaukee, WI (US); Jay Schabelski, Milwaukee, WI (US)

(21) Appl. No.: 17/879,138

(22) Filed: Aug. 2, 2022

Related U.S. Application Data
(60) Provisional application No. 63/228,309, filed on Aug. 2, 2021.

(51) Int. Cl. C02F 1/50; B33Y 10/00; B33Y 80/00; B29C 64/118; C02F 1/28; B01D 15/22

(52) U.S. Cl. CPC C02F 1/50; B33Y 10/00; B33Y 80/00; B29C 64/118; C02F 1/283; B01D 15/22; B29K 2995/0037; B29L 2031/14

(57) ABSTRACT

A method of forming and fluid treatment system includes a vessel that is defined by a body having an inlet constructed to be connected to a fluid source and an outlet that is constructed to be connected to a discharge passage defined by a direction of a fluid flow directed through the body. The body is preferably three-dimensionally (3D) printed as a unitary body and from a filament material to define the entirety of the body including the inlet and the outlet. The vessel is preferably formed of an antimicrobial or other materials configured to manipulate the composition of the fluid flow directed therethrough and via direct contact of the fluid flow with the interior spaces of the body of the vessel.

### CROSS REFERENCE TO RELATED PATENTS

This non-provisional patent application claims priority to U.S. Provisional Patent Application Ser. No. 63/228,309 filed on Aug. 2, 2021 titled “3d Printed Treatment System Constructed Using Enhanced Homogeneous Filament Material and Employing Radial Flow Between Concentric Cylinders and Plates for the Purpose of Treating Fluids and Gases” and the disclosure of which is expressly incorporated herein.

### FIELD OF THE INVENTION

The present invention is directed to a system and method of forming fluid treatment devices that are constructed to manipulate the characteristics of a fluid, whether gas or liquid, directed through the filter treatment device. The fluid treatment devices can preferably be 3d printed from homogenous filament materials and employ radial filtration flows concentric chambers and plates for manipulating the condition or composition of fluids communicated therethrough. The filtration system employs enhanced filament technology that provides multiple stages of fluidic treatment as the fluid progresses through the filtration device between an inlet and a discharge of the device.

### BACKGROUND OF THE INVENTION

The practice of using granulated media (pellets, beads, shapes, etc.) is a well-developed science in the treatment of fluids and gases. In most cases, the media requires direct interaction between the fluid and the filtration media particles. In some cases, additional contact time is needed to allow the media to complete the desired filtration or manipulation of the composition of the filtered fluid flow. The nature of most media devices is to input fluids (or gases) into a large chamber filled with specific media and to give time or provide a fluid presence dwell for the fluid to disburse or dilute throughout the chamber before exiting the vessel as treated fluid.

Most media will interact with and treat fluids or gases quickly as the fluid or gas molecules directly engage the media, however, dwell times associated with achieving the desired filtration and/or manipulation of the gas or liquid fluid flows tends to detract from fluid throughput efficiency and expediency. The size of discrete filtration devices or vessels, and/or the number of discrete fluid filtration devices that are fluidly connected to one another must commonly be increased to achieve a desired fluid throughput and filtration performance. Further, as the volume fluids passed through the filtration system increases, the media tends to degrade and/or become polluted thereby detracting from the efficacy associated with continued use of the filtration device. Although many media containing filtration devices are non-serviceable such that the entirety device must be replaced at the end of the usable life thereof, others provide filtration devices that are constructed to accommodate replaceable and/or replenishable media materials. Replacing the entirety of the filtration device and/or only the media attenuate thereto, increases the costs associated with maintaining continued operation of the filtration device at an operating efficacy that maintains the desired degree of filtration and/or conditioning of the gas and/or liquid fluid flows therethrough.

Whether employed to filter gas or liquid fluid flows, with replaceable or serviceable filter assemblies and/or filter media, such systems commonly include a vessel that is constructed to house the filter elements and which otherwise does not interfere with or otherwise manipulate the composition of the fluid flow directed therethrough. Servicing such filtration devices and/or maintain the desired efficacy associated with operation thereof, as well as the independent construction and formation of the discrete components of such filter assemblies can increase the user costs associated with use of the same. Further still, changes to the construction of, or failure of one or more of the more robust and/or reusable structures of such filtration systems, can further exacerbate user costs in the event the constructions of the vessels and/or the filters and/or media are changed by a manufacturer so as to no longer cooperate with previously acquired filter vessels and/or media or filters.

The present invention discloses a method and filter assembly or filtration system that overcomes or mitigates one or more of the shortcomings discussed above and discloses a unitary filtration system that can be conveniently and economically manufactured and deployed.

### SUMMARY OF THE INVENTION

One aspect of the present invention discloses a fluid treatment system having a vessel defined by a body having an inlet that is constructed to be connected to a fluid source and an outlet constructed to be connected to a discharge passage defined by a direction of a fluid flow directed through the body. The body is three-dimensionally (3D) printed from filament material to define the entirety of the body including the inlet and the outlet and is formed of a material that is effectuates a filtration process upon the fluid passing through the body. In a preferred aspect, the filament material is formed of one or more of a biocide material capable of killing at least one of viruses and bacteria carried on a fluid flow on contact, an activated carbon fiber material selected to at least one of reduce or eliminate targeted contaminants including at least one of heavy metals and volatile organic compounds (VOCs) carried on a fluid flow, and/or combinations thereof.

In one aspect, the fluid flow directed through the fluid treatment system is a water fluid flow and provides a potable water output and/or a water flow suitable for agricultural and/or livestock irrigation and/or watering. In another aspect, the body of the vessel defines a tortious fluid path through the body between the inlet and the outlet and which is formed as the body is 3D printed. In another preferred aspect, the tortious 3D printed fluid path allows the fluid flow directed through the body to experience at least one of varying velocities, varied directions of the fluid flow, and multiple flow paths to attain fluid flow requirements that cannot be constructed from current molding or machining processes. In yet a further preferred aspect, the body defines at least two concentric chambers that are separated from one another along at least a portion thereof by a wall formed during 3D printing of the body.

Another aspect of the present invention discloses a method of forming a fluid treatment device that includes creating a digital model of a body having a fluid inlet and a fluid outlet and a fluid path formed therebetween. A filament material associated with formation of the body is selected so as to be suitable for use during three-dimensional (3D) printing of the body and which will interact with a fluid intended to be communicated through the body. The body is subsequently printed from the digital model from the selected filament. In a preferred aspect, the filament material is selected to at least one of provide a biocide property capable of killing at least one of a bacteria or a virus upon contact of a bacteria or virus carried on the fluid flow with a surface of the body, as an antimicrobial material, reduce or eliminate targeted contaminants such as at least one of heavy metals and volatile organic compounds (VOCs) carried on the fluid flow upon contact of the fluid flow with the body, and/or combinations thereof.

In another preferred aspect, 3D printing the body further defines at least one fluid flow path that includes various portions wherein the fluid flow is directed in opposite directions relative a longitudinal length of the body, defining impervious walls during the 3D printing between discrete portions of adjacent sections associated with the opposite direction flows, and/or defining the fluid flow path so that a fluid flow experiences at least one of a change of velocities, a directional change, and is provided multiple flow paths to satisfy flow requirements that cannot be constructed from molding or machining processes.

A further aspect of the invention discloses a fluid treatment system that includes a vessel that is defined by the three-dimensionally (3D) printed body having an inlet and an outlet. A plurality of concentric chambers that are internal to the body and are defined by the vessel wherein each concentric chamber provides a stage of fluidic treatment. The inlet is configured to receive and intake a fluid flow and sequentially direct the fluid flow to the plurality of concentric chambers and each chamber of the plurality of concentric chambers are configured to receive the fluid flow in a radial direction that is circumferential relative to the chamber and such that each of the plurality of concentric chambers are configured to direct the fluid flow toward the outlet of the vessel.

These and other aspects, objects, features, and advantages of the present invention will be appreciated by those skilled in art will be appreciated from the above disclosure and the following detailed description of the invention.

### BRIEF DESCRIPTION OF THE DRAWINGS

A clear conception of the aspects, objects, advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an elevation cross section view of a fluid treatment system according to a first embodiment of the invention;

FIG. 2 is view similar to FIG. 1 of a fluid treatment system according to another embodiment of the invention;

FIG. 3 is a view similar to FIGS. 1 and 2 of a fluid treatment system according to another embodiment of the invention;

FIG. 4 is a view similar to FIGS. 1-3 of a fluid treatment system according to another embodiment of the invention;

FIG. 5 is a detail view of a portion of the fluid treatment system shown in FIG. 4 taken along line 5-5;

FIG. 6 is a perspective view of a fluid treatment system according to another embodiment of the invention; and

FIG. 7 is an exploded perspective view of fluid treatment system shown in FIG. 6.

### DETAILED DESCRIPTION

In describing the preferred embodiments of the invention which are illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. The various features and advantageous details of the subject matter disclosed herein are explained more fully with reference to the non-limiting embodiments described in detail in the following description.

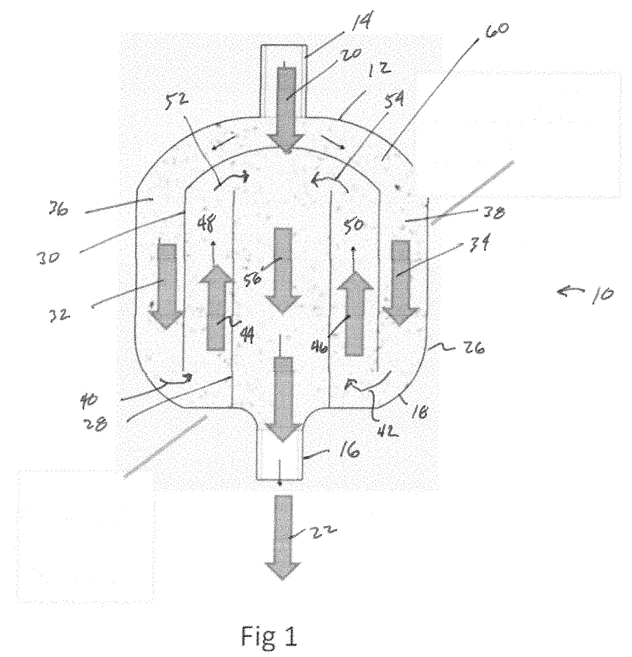

FIG. 1 shows a fluid filtration system, apparatus, or device 10 according to one embodiment of the present application. Device 10 is defined by a vessel 12 having at least one fluid flow inlet 14 and at least one fluid flow outlet 16. Preferably, one or both of inlet 14 and outlet 16 are constructed to directly cooperate with respective fluid conducting fluid flow connections such as compression, glue, or threaded pipe connections, or the like. It is further appreciated that the size and throughput associated with the discrete inlets 14 and/or outlets 16 associated with device 10 can be provided in various sizes in addition to the various connection methodologies available. If is further appreciated that the respective size and throughput of device can be provided in various configurations so as to accommodate varied demands associated with specific applications associated with use of device 10.

Vessel 12 is defined by a preferably unitary continuous body 18 that defines both inlet 14 and outlets 16. In a preferred aspect, each of inlet 14 and outlet 16 are constructed to be fluidly connected to a respective fluid source, indicated by inlet fluid flow arrow 20 and/or respective fluid discharge line, indicated by outlet or discharge fluid flow arrow 22, associated with communicating a respective fluid flow through device 10. As disclosed further below, body 18 of vessel 12 is preferably formed as a continuous unitary body during a three-dimensional (3D) printing operation and from a material that is selected to effectuate a desired filtration activity during passage of the respective fluid flow therethrough and via passage of the fluid flow over those surfaces of device 10 that are exposed thereto.

Body 18 is defined by an exterior wall 26 that generally extends between inlet 14 and outlet 16 and is impervious to the penetration of fluids therethrough. Radially inward from exterior wall 26, body 18 includes one or more partition walls 28, 30 that are constructed to guide the respective fluid flow through vessel 12 from inlet 14 toward outlet 16 thereof. First partition wall 30 separates inlet flow 20 into respective fluid flows 32, 34 and respective cavities 36, 38 between partition walls 30 and exterior wall 26 in a first longitudinal direction. Fluid flows 32, 34 progress in a radially inward direction, indicated by arrows 40, 42 and progress in an opposite longitudinal direction, indicated by arrows 44, 46 and toward respective cavities 48, 50 defined by interior wall 30 and interior wall 28. Fluid flows 44, 46 subsequently travel in respective inward radial directions, indicated by arrows 52, 54, are combined with one another, indicated by arrow 56, and the progress toward outlet 16.

Depending upon the relative degree of filtration required or desired, respective cavities defined between exterior wall 26 and interior walls 30, 28 may or may not include a filtration matrix material 60 configured to allow the fluid flow to pass therethrough and thereover and effectuate a filtration operation. It is appreciated that the degree of filtration necessary for any given application can vary greatly depending on the quality of the inlet fluid condition, whether gas or liquid, and the desired characteristics and/or intended use of the fluid flow discharged from device 10. Preferably, one or more of walls 26, 28, 30 are constructed of a material configured to interact with and effectuate filtration of the fluid flow 20 passing thereover. One or more of partition walls 28, 30 may be constructed in an impervious and/or pervious manner so as to accommodate filtration operation thereof and so as to provide changes in the velocity and/or direction of the travel of the fluid therethrough so as to manipulate the mixing performance associated with utilization of filtration device 10. In a preferred aspect, the entirety of the device 10 is formed by a continuous three-dimensional printing operation as disclosed further below.

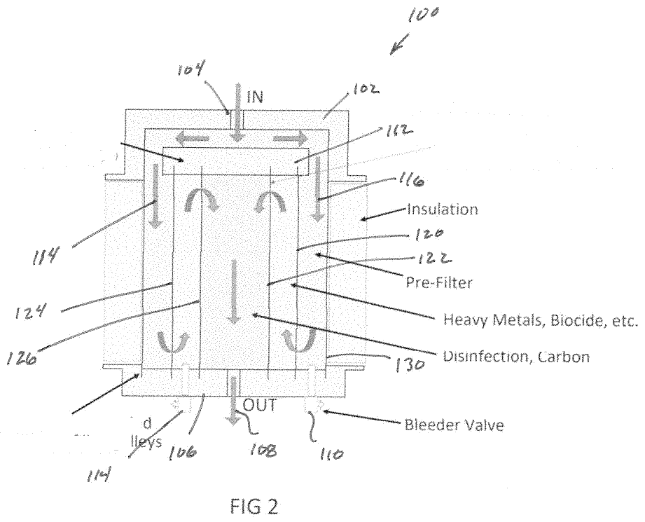

FIG. 2 shows a filtration device 100 constructed in accordance with another embodiment of the present invention. Preferably, filtration device 100 includes one or more discrete components that can be assembled post three dimensional printing operations associated with the formation of the discrete components thereof. Once assembled, fluid flow through device 100 progresses in a manner consistent with the disclosure of applicant's co-pending application U.S. Patent Application Publication No. 2021/0308604 and the disclosure of which is expressly incorporated herein. As disclosed therein, device 100 includes an exterior cap 102 that defines a fluid inlet 104 and another exterior cap 106 that defines the fluid outlet from device 100. Device 100 may include one or more pressure relief or bleeder valves 110, 114 associated with accommodating equalization of operating pressures and/or periodic flushing of filtration device 100 when necessary. An interior cap 112 divides the inlet fluid flow 114 and directs respective fluid flows 114, 116 through device 100. Device 100 includes one or more partition walls 120, 122 and 124, 126 that accommodate the respective longitudinal and radially inward directed passage of fluid flow through device 100 toward outputs 108.

As disclosed further below, one or more of the discrete components or the entirety of filtration device 100, caps 102, 106, 112, walls, 120, 122, 124, 126, and/or an exterior wall 130 can be three-dimensionally printed from materials selected to provide a filtration of the fluid flow passing thereover, there-along, or therethrough. The discrete cavities between caps 102, 106, 112 and walls 130, 122, 120, 124, 126, of filtration device 100, are configured to expose the respective fluid passing thereover to the discrete walls so as to effectuate a desired filtration process thereof. It is envisioned that one or more of the discrete portions of filter device 100 may be formed during a three-dimensional printing operations and subsequently assembled into device 100 and/or that device 100 may be printed as a unitary body in the manner similar to that disclosed above with respect to device 10. It is appreciated that forming one or more of discrete elements of device 100 as a unitary assembly during a three-dimensional printing operation can mitigate or reduce assembly errors and/or be employed to provide a desired sealed interaction between the respective discrete components thereof so as to achieve the desired fluid flow through device 100.

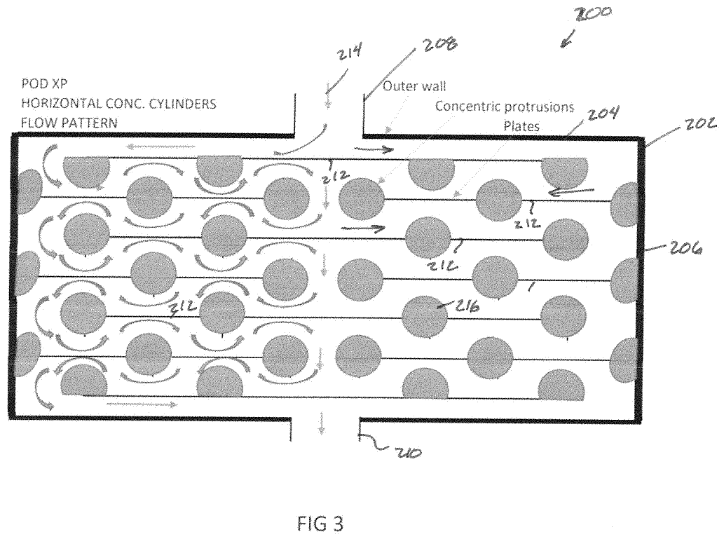

FIG. 3 shows another filtration device 200 according to another embodiment of the present invention. Filtration device 200 includes a vessel 202 defined by a body 204 that defines a generally sealed exterior surface 206 having at least one inlet 208 and at least one fluid outlet 210 defined thereby. Interior to exterior wall 206, device 200 includes one or more fluid directing walls 212 that are configured to direct the fluid flow 214 through device 200. One or more of walls 212 include an agitator 216 associated with manipulating the direction and velocity of fluid flows therethrough. Agitators 216 further operate to increase the surface area to which fluid flow 214 is exposed during the progression of the fluid flow between inlet 208 and toward outlet 210. The agitation and manipulation to the direction and velocity of the fluid flow through device 200, as well as the increase in the surface area associated with walls 212 due to agitators 216 improves the efficacy associated with the filtration process of fluid passing thereover. The discrete alternate flow paths employing the concentric protrusions or humps associated with agitators 216 influence turbulence as the fluid travels across the discrete parallel plates and radially flows to the next plate that incorporates the protrusions as an integral part of each plate. The materials associated with the 3D printed discrete wall portions can be any polymer filament or metallic powder that can be used in a 3D printing processes. Such print material can be designed and produced, or communicated to the discrete print nozzles such that the wall and the integral agitators exhibit homogeneous properties that contribute to the purification or modification of a liquid or gas fluids communicated through the discrete filter device.

Like filtration device 10, one or more of walls 206, 212 and/or agitators 216 are formed during a three-dimensional printing operation and are formed of materials configured to effectuate a filtration operation. Like device 10, it is further appreciated that the cavities between walls 206, 212 and agitators 216 may or may not include supplemental filtration media exposed to the passage of fluid 214 through device 200. It is further appreciated that agitators 216 may be provided in various shapes, sizes, and configurations such as three-dimensionally printed porous mesh, fibers, lattice structures of the like that interconnected and/or extend between the walls of the discrete filtration device. It is appreciated that such a methodology may be employed to varied degrees such that some or no supplemental or loose filtration media is necessary, desired, or can be disposed in discrete passages between the discrete flow directing walls of a discrete filtration device as disclosed further below.

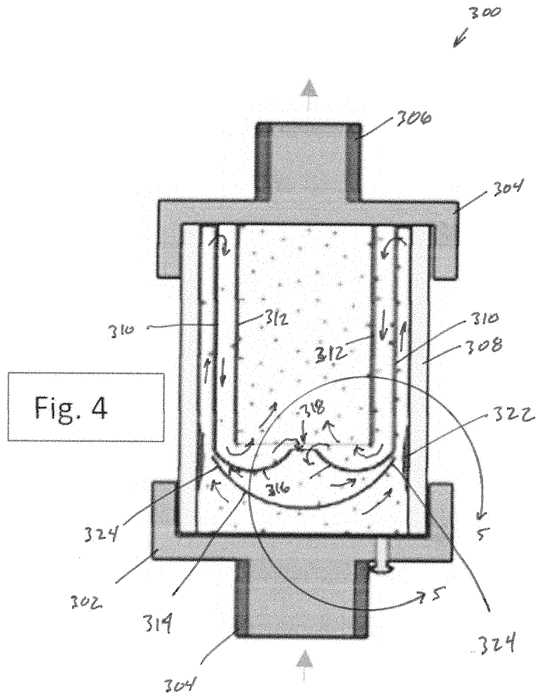

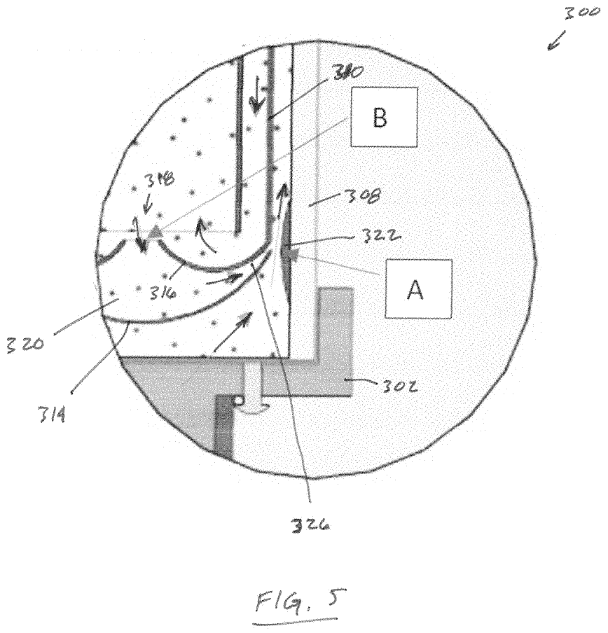

FIGS. 4 and 5 show a filtration device 300 according to another embodiment of the present invention. Filtration device 300 includes an end cap 302 that defines a fluid inlet 304, an end cap 304 that defines a fluid outlet 306, and an exterior wall 308 that extends between caps 302, 304 and is sealingly connected thereto or unitarily formed therewith. Filtration device 300 includes a first radially inward interior wall 310 and another interior wall 312 that is further radially inward relative to wall 310. As disclosed further below, a guide wall 314 is disposed proximate respective curved sections 316 of interior wall 310. An opening 318 is disposed proximate a center portion of curved wall 316 and accommodates passage of a portion of the fluid flow directed through device 300 toward chamber 320 defined between wall 314 and respective curved portions 360. A projection 322 extends from an interior face of exterior wall 308 proximate respective ends 324 of guide wall 314. An opening or passage 326 allows fluid associated with chamber 320 to be reintroduced to the fluid flow communicated from inlet 304 toward projection 322 and to the cavity formed between exterior wall 308 and interior wall 310 of device 300. Projection 322 defines a constriction that is shaped to generate a Venturi effect so as to effectuate the reintroduction of a portion of the fluid flow associated with chamber 320 into the fluid flow directed between wall 308 and interior wall 310 such that portions of the fluid flow directed through device 300 is allowed to repeat multiple trips through the passages defined between wall 308 and wall 310 as well as wall 310 and wall 312 prior to being discharged via outlet 306 from device 300. Said in another way, a portion of the fluid flow that has passed party through filtration device 300 is allowed to be reintroduced to the fluid flow directed through the filtration device 300 at a location that is upstream of the point of origination of the redirected portion of the fluid flow. Such a consideration further improves the efficacy associated with the operation of filtration device 300.

Like device 10, it is further appreciated that walls 308, 310, 312, 314, 316 as well as caps 302, 304 may be constructed of materials configured to effectuate the filtration operation relative to the fluid passing there along. It is further appreciated that the discrete cavities associated with the fluid passages through device 300 may or may not include supplemental filtration media associated with the passage of fluid therethrough, be constructed during the formation process to include lattice, mesh, or lattice structures formed of a filtration response material, and thereby further effectuate filtration of the fluids passed through device 300. Although it is envisioned that device 300 may be formed as a multicomponent assembly, it is further appreciated that device 300 may also be formed by a three-dimensional printing operation so as to define a unitary construction of the vessel and such that the vessel is constructed of filter effectuating materials as disclosed further below.

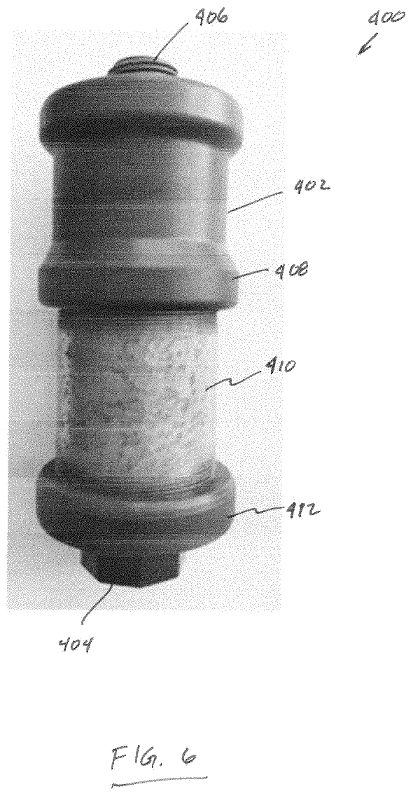

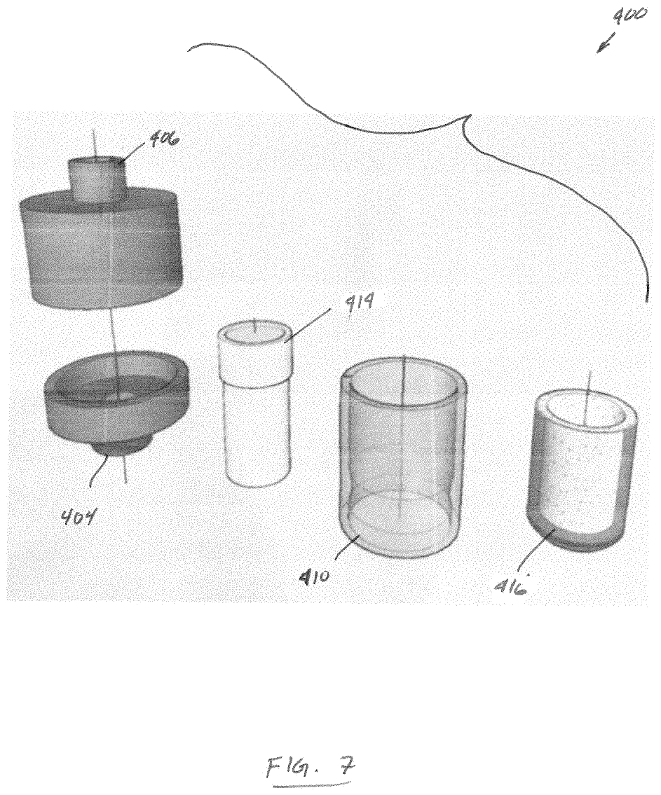

FIGS. 6 and 7 show a filtration device 400 according to another embodiment of the present invention. Device 400 includes a vessel 402 that defines a fluid inlet 404 and a fluid outlet 406. Vessel 402 is defined by a first body 408, a second body 410, and a cap 412 that are sealingly connected to one another and/or formed as a unitary body. Referring to FIG. 7, internal to vessel 402, filtration device 400 includes one or more partition walls 414 and one or more filtration structures or media 416 that are constructed integrally with or to cooperate with one another and the exterior structures of vessel 400 and to effectuate a generally serpentine and periodically radially directed fluid flow through filtration device 400 and in a manner similar to that disclosed above with respect to devices 10, 100, 200, and 300. It should be further appreciated that one or more of internal wall 414, filtration structures or media 416, bodies 408, 410, and cap 412 may be formed individually or concurrently during a three-dimensional printing operation and of materials that do not themselves effectuate a fluid filtration operation and/or of materials that do effectuate a filtration operation via passage of the fluid being filtered thereover and/or therethrough as disclosed further below.

As alluded to above, one or more discrete structures, and/or the entirety of discrete filtration devices 10, 100, 200, 300, and 400 are constructed to provide a filter assembly or system or filter device wherein the housing, vessel, or body or discrete walls associated with the internal constructions thereof and which define at least a portion of the filtration systems or device interacts with the fluid flow directed therethrough so as to manipulate the composition of the fluid flow or remove unwanted materials, such as biological materials such as bacterial or viral elements, volatile organic compounds (VOCs), and/or other elements, such as heavy metals of the like from the fluid flow directed therethrough as the fluid flow passes through the respective filtration device. It is appreciated that, depending on the quality of the incoming fluid flows, whether gas or liquid, whether to be filtered in a manner to provide potable water, or water suitable for other purposes such as irrigation, industrial applications, agricultural process such as livestock tending or the like, the material associated with the formation of the discrete filtration device or portions thereof can be selected to remove components attenuate to the incoming fluid flows. Preferably, filtration of the fluid flow via interaction of the fluid flow with the structure of the filtration vessel does not unduly interfere with pressure, volume and flow characteristics of fluid flows directed through the vessel. Preferably, when configured and produced, the discrete filtration devices can be provided in a more efficient manner such that the design and construction of the discrete filtration device, including the inlets, outlets, fluid flow channels and passages are configured in a manner to provide fluid or gas flows through the filter assembly in a turbulent and less volumetric manner as to ensure contact of the fluid molecules with the surfaces of the filter devices so as to reduce dwell times associated with the desired degree of filtration of the relative incoming fluid while attaining most thorough engagement between the fluid and the structures of the filtration device as possible or necessary to achieve the desired degree of filtration and without unduly detracting from the volume and rates of fluid flow communicated through the respective filtration device.

Three-dimensionally (3D) printing of discrete components or preferably the entirely of discrete ones of devices 10, 100, 200, 300, and/or 400 using enhanced media filaments that are selected to effectuate filtration operations, providing the 3D printed elements in constructions that allow radial concentric flow patterns, yields increased efficacy, smaller dimensions, less costs, and improved and complex filtration and structural engineering capabilities of the resultant filtration devices than can be achieved with comparable granulated media filtration devices and devices manufactured with more customary molding and machining approaches.

The construction of the 3D printed devices incorporate a number of functions that improve the efficiency of device production, reduce costs associated therewith, and attain the desired objectives attenuate to the desired fluid filtration. One object is the construction of an impervious wall that forms outer and inner concentric cylinders or plates with concentric protrusions thereby fascinating the longitudinal and radially directed passage of the fluid through the respective filtration device. Another aspect is the generation of the porous filtration matrix; whether in a mesh, lattice, thin film, fibers, or other such structures; or no matrix, i.e. an unobstructed or empty cavity or passage is formed between and connecting each of the impervious walls that allow desired fluid flows but create turbulence, channel configurations to modulate velocities, and directional changes to mitigate lamellar flows and encourage fluid contact with the discrete fluid facings surfaces of the discrete filtration device. Such considerations allow the discrete filtration devices to be designed to cause the molecules of the discrete fluids, whether liquids such as water or other fluids or gases such as air or other gases, to contact the printed surfaces (walls, matrix, mesh, or other) as it traverses the path between concentric cylinders or plates such that the printed surfaces effectuate a desired filtration thereof.

It is appreciated that each of devices 10, 100, 200, 300, 400 or discrete components thereof as disclosed above can be 3D printed by use of single or multiple enhanced filaments engaged in the process to construct the device or discrete components thereof making the resultant device capable of treatment for specific pollutants and other undesirable soluble and insoluble properties found in the fluids such as liquids (water, etc.) or gasses (air, etc.). Such a consideration allows the pollutant containment method to ensure that that the fluid (or gas) will only come in contact with the homogeneous treatment material used to construct the device and thereby mitigates communication of any filtration media downstream with the resultant filtered or otherwise conditioned fluid flow.

In a preferred aspect, having generated a three-dimensional model associated with generation of a desired filtration device, or discrete components thereof, the discrete device or component thereof can be printed with a 3D printable filament or pellet material selected to produce the desired arresting of target pollutants carried upon the discrete fluid flow. Specific to reduction of biological materials, such as bacteria, viruses, or the like, 3D printable materials can be employed during the 3D printing operations, such as filament engineered and produced from an antimicrobial material, such as NOVEX AMG, are infused into a polymer to produce a pellet, such as Pura sure, that can be employed as the raw material of an antimicrobial filament for 3D printing machines. Other antimicrobial materials, such as organometallics, activated, or functionalized nano materials, can similarly be incorporated into filaments, powders, or pellets to further enhance the filtration performance of discrete devices and in order to satisfy the discrete demands associated with the discrete desired filtration of discrete fluid sources. It is further appreciated that other 3D printable filament, powders, pellets, etc. may be employed and which are selected for their ability to arrest heavy metals, volatile organic compounds (VOCs), or other elements, odors, or the like from the fluid flows passed through the resultant 3D printed filtration device when conditions require such interaction with the discrete fluid flows.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims. The present invention has been described in terms of the preferred embodiment, and it is recognized that equivalents, alternatives and modifications, aside from those expressly stated, are possible and within the scope of the appending claims.

What is claimed is:

1. A fluid treatment system comprising:
a vessel defined by a body having an inlet constructed to be connected to a fluid source and an outlet constructed to be connected to a discharge passage defined by a direction of a fluid flow directed through the body, the body being three-dimensionally (3D) printed from filament material to define the entirety of the body including the inlet and the outlet.

2. The fluid treatment system of claim 1 wherein the filament material is a biocide material capable of killing at least one of viruses and bacteria carried on the fluid flow on contact.

3. The fluid treatment system of claim 1 wherein the filament material is an activated carbon fiber material selected to at least one of reduce or eliminate targeted contaminants including at least one of heavy metals and volatile organic compounds (VOCs) carried on the fluid flow.

4. The fluid treatment system of claim 3 wherein the fluid flow is further defined as a water fluid flow.

5. The fluid treatment system of claim 1 further comprising a tortious fluid path defined by the body when the body is 3D printed.

6. The fluid treatment system of claim 5 further comprising shaping the 3D printed tortious fluid path to allow the fluid flow directed through the body to experience at least one of varying velocities, varied directions of the fluid flow, and multiple flow paths to attain fluid flow requirements that cannot be constructed from current molding or machining processes.

7. The fluid treatment system of claim 1 wherein the body defines at least one of two concentric chambers that are separated from one another along at least a portion thereof by a wall formed during 3D printing of the body and a Venturi that allows mixing of a portion of a fluid flow within the body with a portion of a fluid flow that is upstream relative thereto.

8. A method of forming a fluid treatment device, the method comprising:
creating a digital model of a body having a fluid inlet and a fluid outlet and a fluid path formed therebetween;
selecting a filament material associated with formation of the body and suitable for use during three-dimensional (3D) printing of the body and which will interact with a fluid intended to communicated through the body; and
three-dimensionally (3D) printing the body from the digital model from the selected filament.

9. The method of claim 8 further comprising selecting the filament material to provide a biocide property capable of killing at least one of a bacteria or a virus upon contact of a bacteria or virus carried on the fluid flow with a surface of the body.

10. The method of claim 8 further comprising selecting the filament material to at least one of reduce or eliminate targeted contaminants such as at least one of heavy metals and volatile organic compounds (VOCs) carried on the fluid flow upon contact of the fluid flow with the body.

11. The method of claim 8 wherein 3D printing the body further defines at least one fluid flow path that includes various portions wherein the fluid flow is directed in opposite directions relative a longitudinal length of the body.

12. The method of claim 11 further comprising at least one of defining impervious walls during the 3D printing between discrete portions of adjacent sections associated with the opposite direction flows and allowing at least a portion of a fluid flow communicated through the filter assembly to mix with a fluid flow that is upstream relative thereto.

13. The method of claim 12 further comprising defining the fluid flow path so that a fluid flow experiences at least one of a change of velocities, a directional change, and is provided multiple flow paths to satisfy flow requirements that cannot be constructed from molding or machining processes.

14. The method of claim 8 wherein the filament material is an anti-microbial material.

15. A fluid treatment system comprising:
a vessel that is defined by the three-dimensionally (3D) printed body having an inlet and an outlet;
a plurality of concentric chambers that are internal to the body and defined by the vessel and wherein each concentric chamber provides a stage of fluidic treatment;
the inlet being configured to receive and intake a fluid flow and sequentially direct the fluid flow to the plurality of concentric chambers;
each chamber of the plurality of concentric chambers being configured to receive the fluid flow in a radial direction that is circumferential relative to the chamber, and
wherein the plurality of concentric chambers are each configured to direct the fluid flow toward the outlet of the vessel.

16. The fluid treatment system of claim 15 further comprising a non-pervious wall formed between portions of each of the concentric chambers.

17. The fluid treatment system of claim 16 further comprising at least one of a lattice, a porous mesh, and a plurality of fibers disposed in at least one of the plurality of chambers and formed during formation of the body.

18. The fluid treatment system of claim 17 wherein the at least one of a lattice, a porous mesh, and a plurality of fibers is further configured to at least one of vary a velocity, vary directions of the fluid flow, and provide multiple fluid flow paths to attain fluid flow requirements that cannot be constructed from current molding or machining processes

19. The fluid treatment system of claim 17 wherein the vessel is formed of at least one of a biocide material capable of killing at least one of viruses and bacteria carried on the fluid flow on contact, an activated carbon fiber material selected to at least one of reduce or eliminate targeted contaminants including at least one of heavy metals and volatile organic compounds (VOCs) carried on the fluid flow on contact, and a combination thereof.

20. The fluid treatment system of claim 18 wherein the fluid flow is further defined as a water fluid flow.
